(19) United States
(12) Patent Application Publication
(10) Pub. No.: US 2013/0328656 A1
(43) Pub. Date: Dec. 12, 2013

(54) METHOD OF MANUFACTURING MAGNETIC ELEMENT AND MAGNETIC ELEMENT

(71) Applicant: Shinichi SAKAMOTO, Tokyo (JP)

(72) Inventor: Shinichi SAKAMOTO, Tokyo (JP)

(73) Assignee: SUMIDA CORPORATION, Tokyo (JP)

(21) Appl. No.: 13/905,778

(22) Filed: May 30, 2013

(30) Foreign Application Priority Data
Jun. 8, 2012 (JP) 2012-131184

(51) Int. Cl. H01F 41/02; H01F 17/04

(52) U.S. Cl. CPC H01F 41/02; H01F 17/043
USPC 336/221; 29/606

(57) ABSTRACT

The magnetic element has a first core member, a winding part, and a second core member, and is manufactured by way of at least a winding part placement step of placing the winding part on the face of the first core member on the side on which the core part is provided, such that the core part is positioned within the inner periphery of the winding part, and an injection molding step of injection molding so as to surround the first core member and the winding part with resin material, and in the winding part placement step, the winding part is placed on the face of the first core member on the side on which the core part is provided, with at least a portion of the inner peripheral face of the winding part distanced from the outer peripheral face of the core part.

### CROSS-REFERENCE TO RELATED APPLICATIONS

The present application claims priority from Japanese Patent Application No. 2012-131184 filed on Jun. 8, 2012, the entirety of which is hereby incorporated by reference into this application.

### TECHNICAL FIELD

The present invention relates to a method of manufacturing a magnetic element, and to a magnetic element.

### BACKGROUND ART

With magnetic elements having a magnetic core made of sintered ferrite and a coil (winding part) wherein a conductive wire is wound around this magnetic core, there have been problems such as defects and damage in the core, and the difficulty of assembly when a closed magnetic circuit is to be formed. In order to solve such problems, a method of manufacturing a magnetic resin molded coil (magnetic element) in which a coil is embedded in a magnetic resin mold was proposed in JP-02-249217-A.

Therein, a magnetic resin molded coil is produced by way of: a first molding step of injection molding the magnetic resin at the interior of a coil, or in a part corresponding to the interior of a coil; and a second molding step, preceding or following the first molding step, of injection molding the magnetic resin primarily at the external perimeter of the coil, or in a part corresponding to the external perimeter of the coil. Producing a magnetic resin molded coil by way of these steps makes it possible to prevent deformation of the coil, shifting of the coil away from the center within the mold, and damage to the insulating coating of the coil wire. In addition to which, the yield and reliability can be improved, and the properties thereof can be made consistent.

### DISCLOSURE OF THE INVENTION

Meanwhile, in order to satisfy market requirements, magnetic elements of the sort described above, in which a winding part is embedded in magnetic resin, must have good heat resistance and high inductance. If, for these reasons, the magnetic element is injection molded using a magnetic resin in which large amounts (for example, approximately 75 wt %) of a magnetic powder have been dispersed in a heat resistant resin, such as heat resistant nylon, the viscosity of the magnetic resin will be great, which has a negative impact on the moldability. In this case, if the injection molding is performed with the central core part of the core arranged within the inner periphery of the winding part, the space between the outer peripheral face of the core part and the inner peripheral face of the winding part will not be filled with magnetic resin, but, rather, a gap will be formed.

If a magnetic element in which such a gap has been formed is exposed to a high-temperature environment, the air enclosed in the gap will expand. As a result, parts within the magnetic element will separate and cracks will form, with this gap region as the starting point.

The present invention is a reflection of the matters described above and is directed to providing a method of manufacturing a magnetic element, and a magnetic element manufactured using the same, in which the separation of parts within the magnetic element and the formation of cracks can be prevented, even in high-temperature environments.

The object described above is achieved by the following aspects of the present invention. That is to say, according to the present invention, the method of manufacturing a magnetic element having a first core member made from a resin material in which a magnetic powder is dispersed, and having a substantially plate-like base and a core part protruding from the approximate center of one face of the base; a winding part, formed as a tube by winding a conductive wire, which is placed on the base such that the core part is positioned within an inner periphery of the tube; and a second core member, made from a resin material in which a magnetic powder has been dispersed, which is provided so as to surround a side of the first core member on which the core part is provided and the winding part, is a method comprising at least: a winding part placement step of placing the winding part on the face of the first core member on the side on which the core part is provided, such that the core part is positioned within the inner periphery of the winding part; and an injection molding step of injection molding so as to surround the side of the first core member on which the core part is provided and the winding part with the resin material in which the magnetic powder has been dispersed, wherein, in the winding part placement step, the winding part is placed on the face of the first core member on the side on which the core part is provided, with at least a portion of an inner peripheral face of the winding part distanced from an outer peripheral face of the core part.

In one mode of embodiment of the method of manufacturing a magnetic element according to the present invention, it is preferable that, in the winding part placement step, the winding part is placed on the face of the first core member on the side on which the core part is provided, with at least substantially the entire surface of the inner peripheral face of the winding part, other than in the vicinity of a base side thereof, distanced from the outer peripheral face of the core part.

In another mode of embodiment of the method of manufacturing a magnetic element according to the present invention, it is preferable that an outer peripheral profile shape of the core part and an inner peripheral profile shape of the winding part are similar, and that in the winding part placement step, the winding part is placed on the face of the first core member on the side on which the core part is provided, such that a central axis of the core part and a central axis of the winding part approximately coincide.

In another mode of embodiment of the method of manufacturing a magnetic element according to the present invention, it is preferable that a step is provided on the face of the base on the side on which the core part is provided, on at least a portion of a line corresponding to at least one diameter selected from the inner diameter and the outer diameter of the winding part, at which a central axis of the core part and a central axis of the winding part are assumed to approximately coincide.

In another mode of embodiment of the method of manufacturing a magnetic element according to the present invention, it is preferable that the shape of the core part is any one shape selected from an approximately conical shape, a base-plane side of which is oriented toward the base, and an approximately frustum shape, a base-plane side of which is oriented toward the base, and that in the winding part placement step, at least a portion of the outer peripheral face of the core part on the base side thereof, and at least a portion of the inner peripheral face of the winding part make contact.

In another mode of embodiment of the method of manufacturing a magnetic element according to the present invention, it is preferable that, in the winding part placement step, the winding part is placed on the face of the first core member on the side on which the core part is provided, such that a portion of the inner peripheral face of the winding part and a portion of the outer peripheral face of the core part make contact, extending in the direction of a central axis of the core part.

In another mode of embodiment of the method of manufacturing a magnetic element according to the present invention, it is preferable that there are two or more contact parts where a portion of the inner peripheral face of the winding part and a portion of the outer peripheral face of the core part make contact, extending in the direction of the central axis of the core part.

In another mode of embodiment of the method of manufacturing a magnetic element according to the present invention, it is preferable that the two or more contact parts are arranged at approximately point symmetric positions with respect to the central axis of the core part.

In another mode of embodiment of the method of manufacturing a magnetic element according to the present invention, it is preferable that a combination of an outer peripheral profile shape of the core part and an inner peripheral profile shape of the winding part is at least one combination selected from:
(A) a combination of an approximately circular shape and an approximately triangular shape;
(B) a combination of an approximately circular shape and an approximately quadrangular shape;
(C) a combination of an approximately triangular shape and an approximately circular shape;
(D) a combination of an approximately quadrangular shape and an approximately circular shape;
(E) a combination of an approximately cruciform shape and an approximately circular shape; and
(F) a combination of an approximately cruciform shape and an approximately quadrangular shape.

According to the present invention, the magnetic element comprising: a first core member made from a resin material in which a magnetic powder is dispersed, and having a substantially plate-like base and a core part protruding from the approximate center of one face of the base; a winding part, formed as a tube by winding a conductive wire, which is placed on the base such that the core part is positioned within an inner periphery of the tube; and a second core member made from a resin material in which a magnetic powder has been dispersed, which is provided so as to surround a side of the first core member on which the core part is provided and the winding part, is manufactured by way of at least: a winding part placement step of placing the winding part such that the core part is positioned within the inner periphery of the winding part; and an injection molding step of injection molding using the resin material in which the magnetic powder has been dispersed, so as to surround the side of the first core member on which the core part is provided and the winding part, wherein, in the winding part placement step, the winding part is placed on the face of the first core member on the side on which the core part is provided, with at least a portion of an inner peripheral face of the winding part distanced from an outer peripheral face of the core part

### Effect of the Invention

By virtue of the present invention, a method of manufacturing a magnetic element and a magnetic element manufactured using the same can be provided, with which the separation of parts and the formation of cracks within the magnetic element can be prevented, even in high-temperature environments.

### BRIEF DESCRIPTION OF THE DRAWINGS

FIG. 1 consists of schematic views showing one example of a magnetic element produced by the method of manufacturing a magnetic element of the present mode of embodiment. Here, FIG. 1A is a schematic sectional view in the case where the magnetic element is cut along a plane including the central axis of the core part of the first core member; and FIG. 1B is a schematic end view in the case where the magnetic element is cut along a plane orthogonal to the central axis of the core part, taken along line A1-A2 in FIG. 1A.

FIG. 2 consists of schematic sectional views showing one example of the method of manufacturing a magnetic element of the present mode of embodiment. Here, FIG. 2A is a schematic sectional view showing the winding part placement step, and FIG. 2B is a schematic sectional view showing the injection molding step.

FIG. 3 consists of schematic views showing a specific example of the winding part placement step in the method of manufacturing a magnetic element of the present mode of embodiment. Here, FIG. 3A is a schematic sectional view in the case of cutting along a plane including the central axis of the core part of a first core member, and FIG. 3B is a schematic end view in the case of cutting along a plane orthogonal to the central axis of the core part, taken along line A1-A2 in FIG. 3A. FIG. 4 consists of schematic views showing another specific example of the winding part placement step (a variant of the example shown in FIG. 3) in the method of manufacturing a magnetic element of the present mode of embodiment. Here, FIG. 4A is a schematic sectional view in the case of cutting along a plane including the central axis of the core part of a first core member, and FIG. 4B is a schematic end view in the case of cutting along a plane orthogonal to the central axis of the core part, taken along line A1-A2 in FIG. 4A.

FIG. 5 is a schematic sectional view showing another specific example of the winding part placement step in the method of manufacturing a magnetic element of the present mode of embodiment.

FIG. 6 is a schematic sectional view showing another specific example of the winding part placement step (a variant of the example shown in FIG. 5) in the method of manufacturing a magnetic element of the present mode of embodiment.

FIG. 7 is a schematic sectional view showing another specific example of the winding part placement step (a variant of the example shown in FIG. 5) in the method of manufacturing a magnetic element of the present mode of embodiment.

FIG. 8 consists of schematic views showing another specific example of the winding part placement step in the method of manufacturing a magnetic element of the present mode of embodiment. Here, FIG. 8A is a schematic sectional view in the case of cutting along a plane including the central axis of the core part of the first core member, and FIG. 8B is a top view in which the first core member, on which the winding part has been placed, is seen from the direction of the arrow U in FIG. 8A (that is to say, a top view of the first core member on the side on which the winding part was placed).

FIG. 9 consists of schematic views showing another specific example of the winding part placement step (a variant of the example shown in FIG. 8) in the method of manufacturing a magnetic element of the present mode of embodiment. Here, FIG. 9A is a schematic sectional view in the case of cutting along a plane including the central axis of the core part of the first core member, and FIG. 9B is a top view in which the first core member, on which the winding part has been placed, is seen from the direction of the arrow U in FIG. 9A (that is to say, a top view of the first core member on the side on which the winding part was placed).

FIG. 10 consists of schematic views showing another specific example of the winding part placement step (a variant of the example shown in FIG. 8) in the method of manufacturing a magnetic element of the present mode of embodiment. Here, FIG. 10A is a schematic sectional view in the case of cutting along a plane including the central axis of the core part of the first core member, and FIG. 10B is a top view in which the first core member, on which the winding part has been placed, is seen from the direction of the arrow U in FIG. 10A (that is to say, a top view of the first core member on the side on which the winding part was placed).

FIG. 11 consists of schematic views showing another specific example of the winding part placement step in the method of manufacturing a magnetic element of the present mode of embodiment. Here, FIG. 11A is a schematic sectional view in the case of cutting along a plane including the central axis of the core part of the first core member, and FIG. 11 B is a schematic end view in the case of cutting along a plane orthogonal to the central axis of the core part, taken along line A1-A2 in FIG. 11A.

FIG. 12 consists of schematic views showing another specific example of the winding part placement step (a variant of the example shown in FIG. 11) in the method of manufacturing a magnetic element of the present mode of embodiment. Here, FIG. 12A is a schematic sectional view in the case of cutting along a plane including the central axis of the core part of the first core member, and FIG. 12B is a schematic end view in the case of cutting along a plane orthogonal to the central axis of the core part, taken along line A1-A2 in FIG. 12A.

FIG. 13 consists of schematic sectional views showing examples of horizontal sectional shapes of core parts in the first core member in the method of manufacturing a magnetic element of the present mode of embodiment

FIG. 14 consists of schematic sectional views showing examples of horizontal sectional shapes of winding parts in the method of manufacturing a magnetic element of the present mode of embodiment

FIG. 15 consists of schematic sectional views (sectional views showing horizontal sectional shapes) showing other specific examples of the winding part placement step in the method of manufacturing a magnetic element of the present mode of embodiment. Here, in terms of horizontal sectional shapes, FIG. 15A is a view showing an example in which a circular core part and a concentric equilateral triangular winding part are combined; FIG. 15B is a view showing an example in which a circular core part and a concentric square winding part are combined; FIG. 15C is a view showing an example in which an equilateral triangular core part and a concentric circular winding part are combined; FIG. 15D is a view showing an example in which a square core part and a concentric circular winding part are combined; FIG. 15E is a view showing an example in which an approximately cruciform core part and a concentric circular winding part are combined; and FIG. 15F is a view showing an example in which a cruciform core part and a concentric square winding part are combined.

FIG. 16 consists of schematic sectional views (sectional views showing horizontal sectional shapes) showing other specific examples of the winding part placement step in the method of manufacturing a magnetic element of the present mode of embodiment. Here, in terms of horizontal sectional shapes, FIG. 16A is a view showing an example in which a square core part and a concentric square winding part are combined, and FIG. 16B is a view showing an example in which the relative positional relationship between the core part and the winding part is different from that in the example shown in FIG. 16A.

FIG. 17 consists of schematic sectional views showing one example of a magnetic element produced by a conventional method of manufacturing a magnetic element. Here, FIG. 17A is a schematic sectional view in the case of cutting along a plane including the central axis of the core part of a first core member, and FIG. 17B is a schematic end view in the case of cutting along a plane orthogonal to the central axis of the core part, taken along line A1-A2 in FIG. 17A.

### BEST MODE FOR CARRYING OUT THE INVENTION

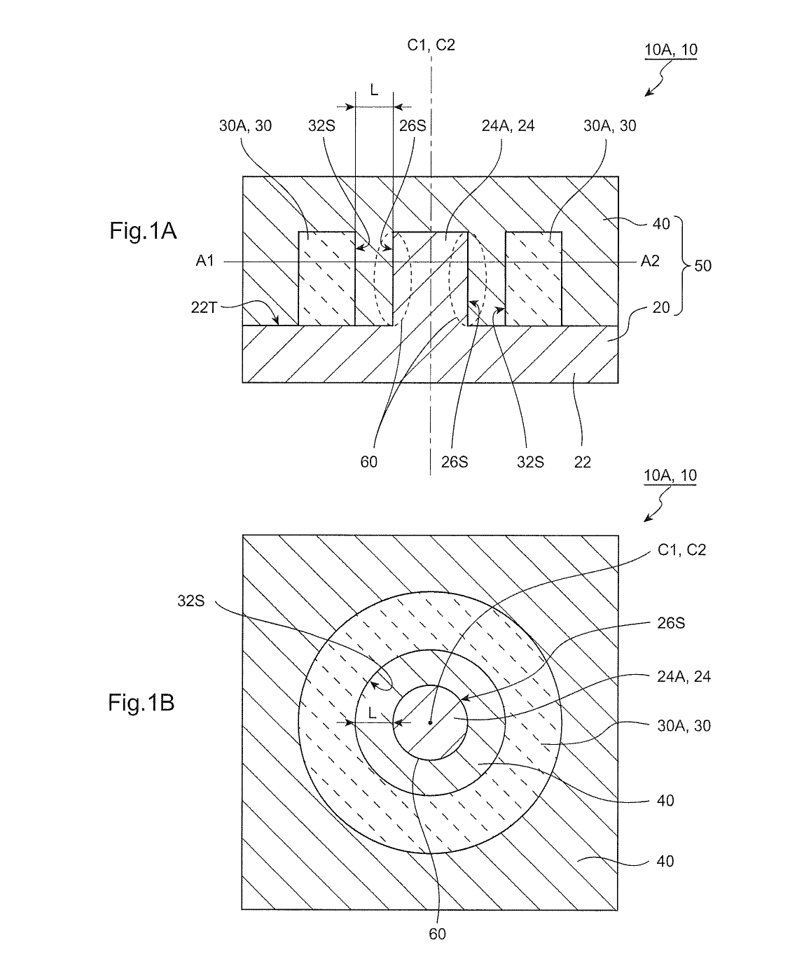

FIG. 1 is a schematic view showing one example of a magnetic element produced by the method of manufacturing a magnetic element of the present mode of embodiment. Here, FIG. 1A is a schematic sectional view in the case of cutting along a plane including the central axis of the core part of a first core member, and FIG. 1B is a schematic end view in the case of cutting along a plane orthogonal to the central axis of the core part, taken along line A1-A2 in FIG. 1A.

The magnetic element 10 shown in FIG. 1 has: a first core member 20 having a substantially plate-like base 22 and a core part 24A (24) that projects from the approximate center of one face (top face 22T) of the base 22; a winding part 30A (30) formed by way of winding a conductive wire (not shown in the drawing) so as to produce a tube, which is arranged on the base 22 such that the core part 24A is positioned within the inner periphery of the tube; and a second core member 40 provided so as to surround the side of the first core member 20 on which the core part 24A is provided and the winding part 30A. Here, the members that constitute the first core member 20 and the second core member 40 are made from a resin material in which a magnetic powder has been dispersed (magnetic resin).

Note that, in the example shown in FIG. 1, the core part 24A has a circular cylinder shape, the winding part 30A has a circular tube shape, the planar face of the base 22 has a square plate shape, and the second core member 40 has a bottomed quadrangular tube shape. In addition, the central axis C1 of the core part 24 coincides with the central axis C2 of the winding part 30.

However, so long as the core part 24 forms a protrusion that projects from the approximate center of the top face 22T, there are no particular restrictions on the shape thereof, and so long as the winding part 30 is tubular, there are likewise no particular restrictions on the shape thereof. However, columnar shapes such as cylinders or polygonal columns are generally preferred for the core part 24. Furthermore, so long as the shape of the base 22 allows for the provision of the core part 24 in the approximate center of one face thereof, and allows the winding part 30 to be arranged on the face on the side on which the core part 24 is provided (top face 22T) there are no particular restrictions thereon, and normally any shape may be used, so long as this is substantially plate-like. Moreover, so long as the second core member 40 is a bottomed tube shape, there are no particular restrictions on the shape thereof. Furthermore, the central axis C1 of the core part 24 and the central axis C2 of the winding part 30 may be distant from one another.

Furthermore, the magnetic element 10 shown in FIG. 1 is one wherein the winding part 30A is arranged on the face of the first core member 20 on the side on which the core part 24 is provided (top face 22T), with at least a portion of the inner peripheral face 32S of the winding part 30A distanced from the outer peripheral face 26S of the core part 24A. Note that, in the magnetic element 10 illustrated in FIG. 1, the winding part 30A is arranged on the face of the first core member 20 on the side on which the core part 24 is provided, with the entire inner peripheral face 32S of the winding part 30A distanced from the outer peripheral face 26S of the core part 24.

That is to say, as illustrated by the magnetic element 10 shown in FIG. 1, a magnetic element manufactured by the method of manufacturing a magnetic element of the present mode of embodiment is configured so as to comprise core members 50 (first core member 20 and second core member 40) and a winding part 30, which is arranged within the core members 50, the core members 50 including a first matrix (which is to say, the matrix corresponding to the first core member 20) and a second matrix (which is to say, the matrix corresponding to the second core member 40), which are adjacent to each other, such that at least a portion 60 of the interface between the first matrix 20 and the second matrix 40 (the interface in the range surrounded by the dashed line in the FIG. 1A) is present at the interior of the region within the inner periphery of the winding part 30.

Next, with the magnetic element 10 shown in FIG. 1, the central axis C1 of the core part 24A and the central axis C2 of the winding part 30A coincide, and the minimum distance between the outer peripheral face 26S and the inner peripheral face 32S (distance L) is constant in the peripheral direction.

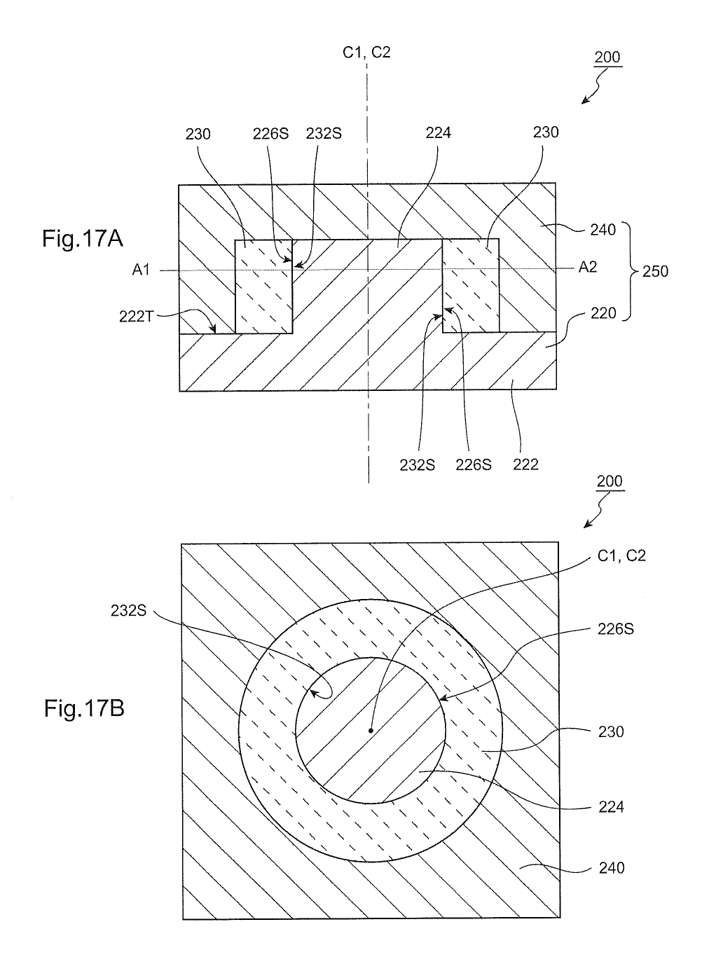

Meanwhile, a conventional magnetic element wherein the winding part is arranged within a core member comprising a magnetic resin has the configuration shown in FIG. 17. Here, in FIG. 17, parts corresponding to those shown in FIG. 1 are indicated by the same reference numerals, to which a third digit has been added. As will be clear by way of comparing FIG. 1 and FIG. 17, the conventional magnetic element 200 has a configuration that is generally similar to that of the magnetic element 10 illustrated in FIG. 1, but the winding part 230 is arranged on the face of the first core member 220 on the side on which the core part 224 is provided, with the entire inner peripheral face 232S of the winding part 230 substantially in generally close contact with the outer peripheral face 226S of the core part 224. In other words, with the conventional magnetic element 200, at the interior of the region within the inner periphery of the winding part 230, there is substantially no interface between the first matrix 220 and the second matrix 240 that constitute the core members 250.

Next, the conventional magnetic element 200 illustrated in FIG. 17 is produced by way of a process wherein the second core member 240 is injection molded onto a component wherein the winding part 230 has been placed on the first core member 220, with the entire inner peripheral face 232S of the winding part 230 substantially in generally close contact with the outer peripheral face 226S of the core part 224. For this reason, during injection molding, the magnetic resin cannot sufficiently penetrate between the inner peripheral face 232S of the winding part 230 and the outer peripheral face 226S of the core part 224, resulting in the formation of minute gaps in this area. If air that is trapped in such gaps in this manner is heated to high temperatures, the expansion of the air will cause separation between the winding part 230 and the core part 224, with these gaps as the starting points, and in the event that this separation phenomena is further propagated to other locations, cracks will form in the magnetic element 200.

As opposed to this, with the magnetic element 10, the winding part 30A is placed on the top face 22T of the first core member 20, with at least a portion of the inner peripheral face 32S of the winding part 30A distanced from the outer peripheral face 26S of the core part 24A. Accordingly, when the second core member 40 is injection molded, it is extremely easy to fill the large space formed between the inner peripheral face 32S of the winding part 30A and the outer peripheral face 26S of the core part 24A with magnetic resin, without any gaps. It is, therefore, possible to prevent the formation of gaps. Consequently, with the magnetic element 10, there is no risk of air that is trapped in gaps, such as those described above, expanding in high temperature environments. In addition, it is possible to more reliably prevent separation between the first matrix 20 and the second matrix 40, as well as the formation of cracks in the magnetic element 10 resulting from such separation.

In other words, in the method of manufacturing a magnetic element of the present mode of embodiment, in order to prevent separation and cracking, the winding part 30 is placed on the top face 22T of the first core member 20, with at least a portion of the inner peripheral face 32S of the winding part 30 distanced from the outer peripheral face 26S of the core part 24. Here, the phrase “distanced from” means separated by a considerably great distance as compared to the conventionally common dimensional clearance of up to approximately 0.2 mm, which is provided between the inner peripheral face 232S of the winding part 230 and the outer peripheral face 226S of the core part 224 in the manufacture of the magnetic element 200 shown in FIG. 17. There are no particular restrictions on this distance, so long as it is a distance that is considerably greater than the aforementioned clearance. For example, normally, in the example shown in FIG. 1, the minimum distance L between the outer peripheral face 26S and the inner peripheral face 32S is preferably no less than 0.3 mm, and more preferably no less than 0.5 mm. Meanwhile, while there are no particular upper limits on the distance L, in practice this is no greater than 10 mm.

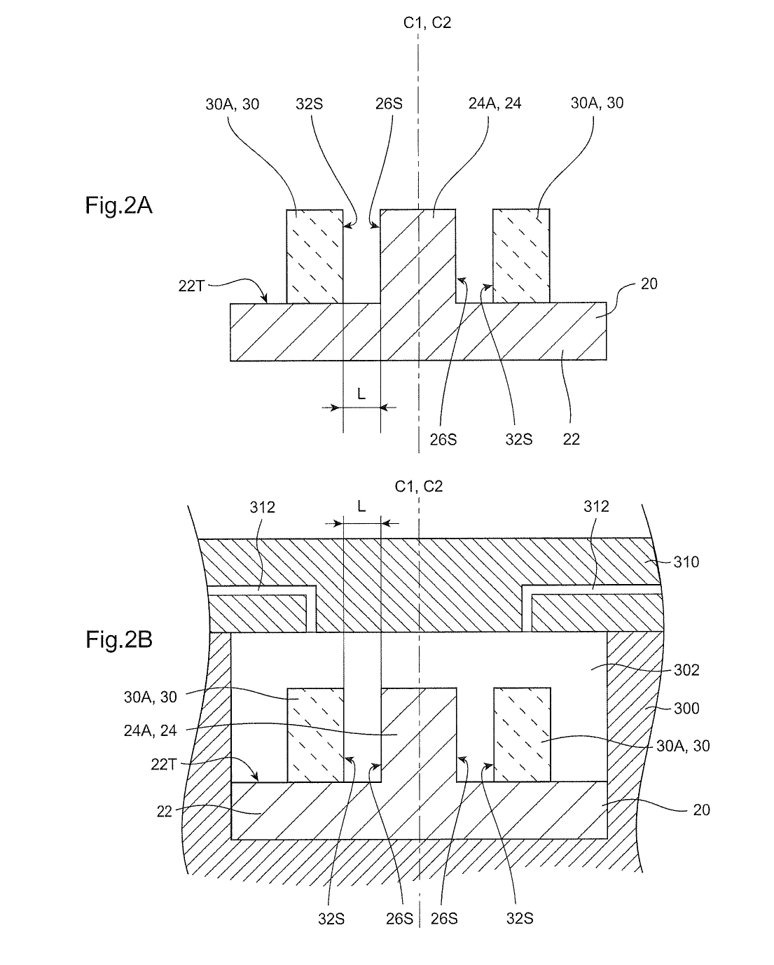

The magnetic element 10 illustrated in FIG. 1 is produced by way of a winding part placement step and an injection molding step. FIG. 2 is a schematic sectional view showing one example of the method of manufacturing a magnetic element of the present mode of embodiment, and more specifically showing a method of manufacturing the magnetic element 10 shown in FIG. 1. Here, 2A is a schematic sectional view showing the winding part placement step, and FIG. 2B is a schematic sectional view showing the injection molding step.

First, in the winding part placement step, as illustrated in FIG. 2A, the winding part 30 is placed on the face of the first core member 20 on the side on which the core part 24 is provided (top face 22T), such that the core part 24 is positioned within the inner periphery of the winding part 30. Note that, in the winding part placement step, it is necessary that the winding part 30 be placed on the face of the first core member 20 on the side on which the core part 24 is provided (top face 22T), with at least a portion of the inner peripheral face 32S of the winding part 30 distanced from the outer peripheral face 26S of the core part 24.

Here, in the case of producing the magnetic element 10 shown in FIG. 1, the winding part 30A is placed on the top face 22T of the first core member 20, with the entire inner peripheral face 32S of the winding part 30A distanced from the outer peripheral face 26S of the core part 24A. Note that the first core member 20 that is used in the winding part placement step is prepared in advance by way of injection molding.

In the injection molding step, the injection molding is performed so as to surround the side of the first core member 20 on which the core part 24 was placed and the winding part 30 with a resin material in which a magnetic powder has been dispersed.

Here, in the case where the magnetic element 10 as shown in FIG. 1 is to be produced, the injection molding can, for example, be performed as shown in FIG. 2B. First, a pair of molds (a first mold 300 and a second mold 310) is used for the injection molding. Then, when the injection molding is performed, the first core member 20 and the winding part 30A that has been placed on the top face 22T of the first core member 20 are arranged at the bottom of a cavity 302 in the first mold 300. Note that the winding part placement step may be performed in advance outside of the cavity 302, or may be performed in the cavity 302. Next, the opening provided at the top of the cavity 302 is tightly closed by the second mold 310 (mold closing). Then, molten magnetic resin is injected into the cavity 302, via runners 312 that are provided in the second mold 310. As a result, the interior of the cavity 302 is filled with the magnetic resin such that the side of the first core member 20 on which the core part 24A was placed and the winding part 30A are surrounded. At this point, because the minimum distance L is sufficiently great, the large space that is formed between the inner peripheral face 32S of the winding part 30A and the outer peripheral face 26S of the core part 24A will be filled with magnetic resin, without gaps.

Then, after dwelling and cooling, the first mold 300 and the second mold 310 are separated (mold opening), and, lastly, the magnetic element 10 that has been formed in the cavity 302 is removed.

Note that a pass-through hole (not shown in the drawing) is provided in at least one of the molds, selected from the first mold 300 and the second mold 310, through which the end of the conductive wire (not shown in the drawing) that constitutes the winding part 30 passes from the interior of the cavity 302 to the exterior. Thus, the end of the conductive wire that leads out from the winding part 30A is arranged in the pass-through hole prior to the injection molding.

There are no particular restrictions on the manner in which the winding part 30 is placed in the winding part placement step, so long as at least a portion of the inner peripheral face 32S of the winding part 30 is distanced from the outer peripheral face 26S of the core part 24. However, in specific terms, it is preferable that the manner in which the winding part 30 is placed be selected from the following first placement mode and second placement mode. Hereafter, the first placement mode and the second placement mode are described in detail, in that order, as concrete examples of the winding part placement step:
(1) a placement mode (first placement mode) wherein the winding part 30 is placed with at least substantially the entire surface of the inner peripheral face 32S of the winding part, other than in the vicinity of the base 22 side thereof, distanced from the outer peripheral face 26S of the core part 24; and,
(2) a placement mode (second placement mode) wherein the winding part 30 is placed such that a portion of the inner peripheral face 32S of the winding part 30 and a portion of the outer peripheral face 26S of the core part 24 are in contact with each other, in the peripheral direction of the core part 24.

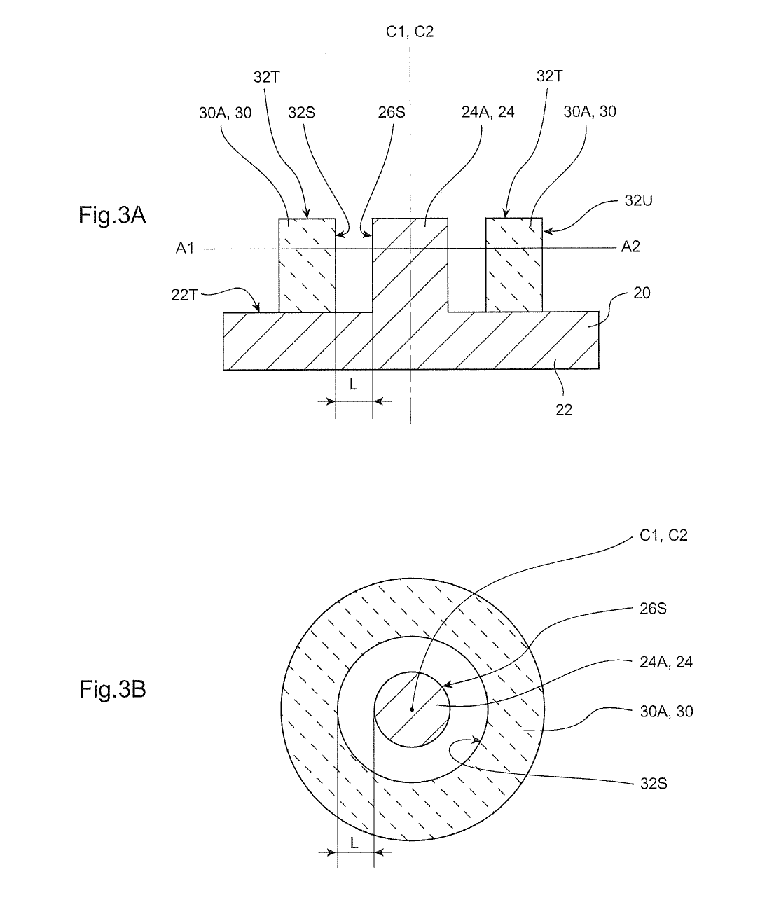

First, specific examples of the first placement mode are shown in FIG. 3 to FIG. 10. Here, FIG. 3 is a schematic view showing one example of the winding part placement step, and FIG. 4 is a variant of the example shown in FIG. 3. Note that FIG. 3A and FIG. 4A are schematic sectional views in the case of cutting along a plane including the central axis of the core part of the first core member. Furthermore, FIG. 3B is a schematic end view in the case of cutting along a plane orthogonal to the central axis of the core part, taken along line A1-A2 in FIG. 3A, and FIG. 4B is a schematic end view in the case of cutting along a plane orthogonal to the central axis of the core part, taken along line A1-A2 in FIG. 4A.

The placement mode shown in FIG. 3 is the same as the placement mode shown in FIG. 2, and, more specifically, shows the placement mode when the magnetic element 10 shown in FIG. 1 is manufactured. In the example shown in FIG. 3, the winding part 30A is placed with at least substantially the entire surface of the inner peripheral face 32S of the winding part 30A, other than in the vicinity of the base 22 side thereof, distanced from the outer peripheral face 26S of the core part 24A, and, moreover, the entire inner peripheral face 32S of the winding part 30A including even the portion in the vicinity of the base 22 side thereof, distanced from the outer peripheral face 26S of the core part 24A. In other words, in the example shown in FIG. 3, the winding part 30A is placed with the entire surface of the inner peripheral face 32S of the winding part 30A distanced from the entire surface of the outer peripheral face 26S of the core part 24. Consequently, when the injection molding is performed, there is almost no risk of gaps forming between the entire surface of the inner peripheral face 32S of the winding part 30A and the entire surface of the outer peripheral face 26S of the core part 24A due to magnetic resin filling problems.

In addition, the outer peripheral profile shape (which is to say, circular) of the core part 24A and the inner peripheral profile shape (which is to say circular) of the winding part 30A are similar, and the winding part 30A is placed on the face of the first core member 20 on which the core part 24A is provided (top face 22T) such that the central axis C1 of the core part 24A and the central axis C2 of the winding part 30A coincide. Note that, so long as the two central axes C1 and C2 approximately coincide, it is not necessary for the two central axes C1 and C2 to perfectly coincide. Consequently, the minimum distance L between the inner peripheral face 32S of the winding part 30A and the outer peripheral face 26S of the core part 24A is always constant or approximately constant in the peripheral direction.

Meanwhile, if the distance L varies, or is inconsistent, in the peripheral direction, when the distance L approaches the minimum dimensional clearance provided between the inner peripheral face 232S of the winding part 230 and the outer peripheral face 226S of the core part 224 in the conventional magnetic element 200, gaps will tend to form in this region. However, as described above, so long as the distance L is always constant, or approximately constant, in the peripheral direction, it is extremely easy to prevent the problems described above from occurring.

However, with the placement mode shown in FIG. 3, the winding part 30A is placed on the top face 22T, which is completely flat other than in the region where the core part 24A is provided. Consequently, the winding part 30A can easily shift in the direction parallel to the top face 22T, in the winding part placement step and in the injection molding step. If slippage occurs in this manner, such that the distance L is inconsistent in the peripheral direction, gaps will tend to occur as described above. In addition, there will be greater inconsistency in the electrical characteristics of multiple magnetic elements manufactured by way of the method of manufacturing a magnetic element of the present mode of embodiment.

Nonetheless, in the case of manufacturing low-end magnetic elements for which comparatively large inconsistencies in quality are acceptable, it is not absolutely necessary that the central axes coincide as illustrated in FIG. 3, but, rather, the configuration may be such that, for example as illustrated in FIG. 4, the central axis C1 of the core part 24A does not coincide with the central axis C2 of the winding part 30A. In this case, while there is a slightly greater possibility of gaps occurring in the region for which the length L is minimal, as indicated by Lₘᵢₙ, the possibility of gaps occurring is much smaller than with the magnetic element 200 illustrated in FIG. 17 (a configuration in which the entire surface of the outer peripheral face 226S of the core part 224 and the entire surface of the inner peripheral face 232S of the winding part 230 are substantially in generally close contact in the peripheral direction). Note that, the example shown in FIG. 4 is configured in the same manner as the example shown in FIG. 3, other than in that the central axis C1 and the central axis C2 thereof do not coincide.

Meanwhile, in the method of manufacturing a magnetic element of the present mode of embodiment, in order to prevent shifting of the winding part 30, after placing the winding part 30, and particularly during injection molding, the winding part 30 may be fixed in place with a fixing member, so that the position of the winding part 30 does not shift. For example, a fixing member may be pressed against the top face 32T of the winding part 30 so as to press the winding part 30 against the top face 22T of the base 22 during injection molding. However, such methods complicate the injection molding process. As a result, productivity may be reduced.

In order to solve such problems, it is preferable to provide a step on the top face 22T of the first core member. Specifically, a step can be provided on the face of the base 22 on the side on which the core part 24 is provided (top face 22T), on at least a portion of a line corresponding to at least one diameter selected from the inner diameter and the outer diameter of the winding part 30, at which the central axis C1 of the core part 24 and the central axis C2 of the winding part 30 are assumed to approximately coincide. In this case, a portion of inner peripheral face 32S and/or the outer peripheral face 32U of the winding part 30, in the vicinity of the base 22 side thereof, is in contact with the stepped portion. Consequently, shifting of the position of the winding part 30 can easily be prevented.

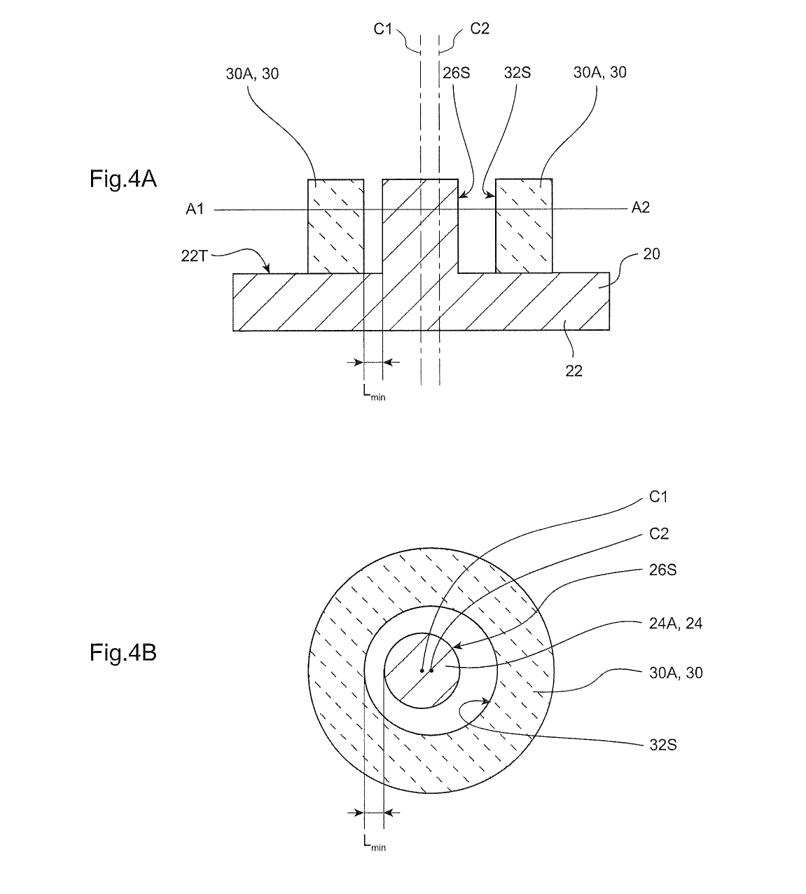

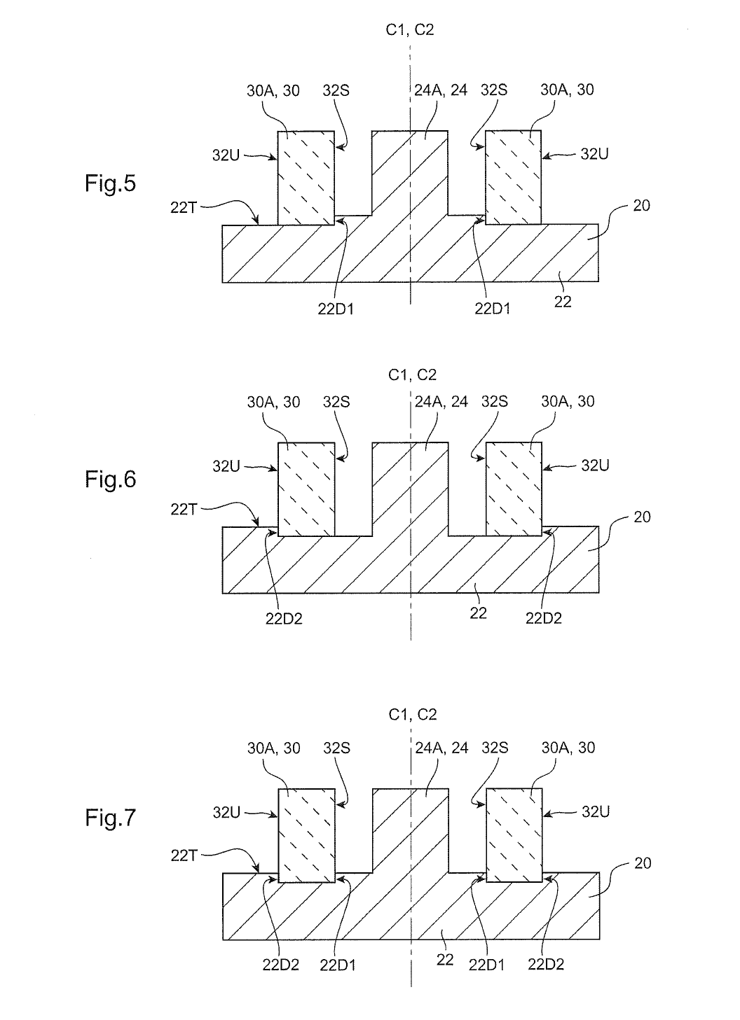

FIGS. 5 to 7 are schematic sectional views showing other specific examples of the winding part placement step, and more specifically showing one example of a case in which a step has been provided on the top face 22T of the first core member 20 from the example shown in FIG. 3. Here, in the example shown in FIG. 5, a step 22D1 is provided on a line corresponding to the inner diameter of the winding part 30A. Thus, a portion of the inner peripheral face 32S of the winding part 30A, in the vicinity of the base 22 side thereof, makes contact with the step 22D1, whereby shifting of the position of the winding part 30A can easily be prevented. Furthermore, in the example shown in FIG. 6, a step 22D2 is provided on a line corresponding to the outer diameter of the winding part 30A. Thus, a portion of the outer peripheral face 32U of the winding part 30A, in the vicinity of the base 22 side thereof, makes contact with the step 22D2, whereby shifting of the position of the winding part 30A can easily be prevented. Moreover, in the example shown in FIG. 7, a step 22D1 is provided on a line corresponding to the inner diameter of the winding part 30A and a step 22D2 is provided on a line corresponding to the outer diameter of the winding part 30A. Thus, a portion of the inner peripheral face 32S of the winding part 30A, in the vicinity of the base 22 side thereof, makes contact with the step 22D1, and a portion of the outer peripheral face 32U of the winding part 30A, in the vicinity of the base 22 side thereof, makes contact with the step 22D2, whereby shifting of the position of the winding part 30A can more reliably be prevented

Note that the step 22D1 may be provided continuously in the peripheral direction, or maybe provided discontinuously in the peripheral direction. However, if the step 22D1 is provided discontinuously in the peripheral direction, which is to say if a plurality of steps 22D1 are provided, it is preferable that the plurality of steps 22D1 be arranged in positions that are approximately symmetrical with respect to the central axes C1, C2. The same applies for the steps 22D2. Note that the steps 22D1, 22D2 can be formed by way of providing a recess in the top face 22T and/or by way of disposing a protrusion on the top face 22T, as is suitable.

Furthermore, the step faces of the steps 22D1 and 22D2 illustrated in FIGS. 5 to 7 are perpendicular faces parallel to the central axes C1, C2, but within a range in which this is not detrimental to the function of preventing the position of the winding part 30A from shifting, these may be inclined faces having a suitable degree of inclination with respect to the central axes C1, C2.

Furthermore, in the method of manufacturing a magnetic element of the present mode of embodiment, in order to prevent the position of the winding part 30 from shifting, instead of using a step 22D1, 22D2 on the top face 22T of the base 22, the outer peripheral face 26S of the core part 24A, on the base 22 side thereof, may be used.

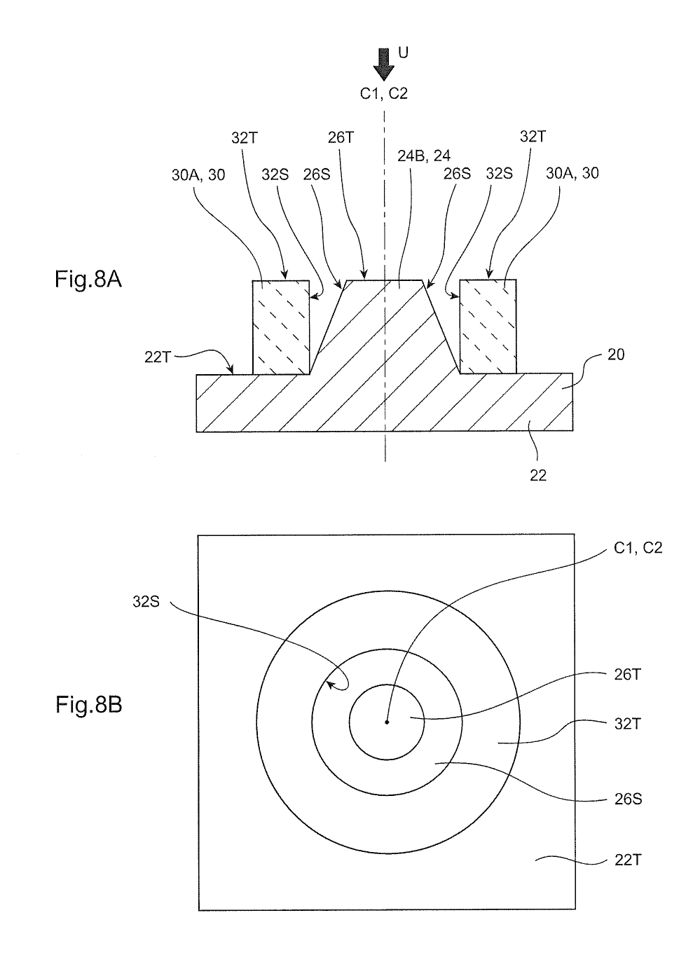

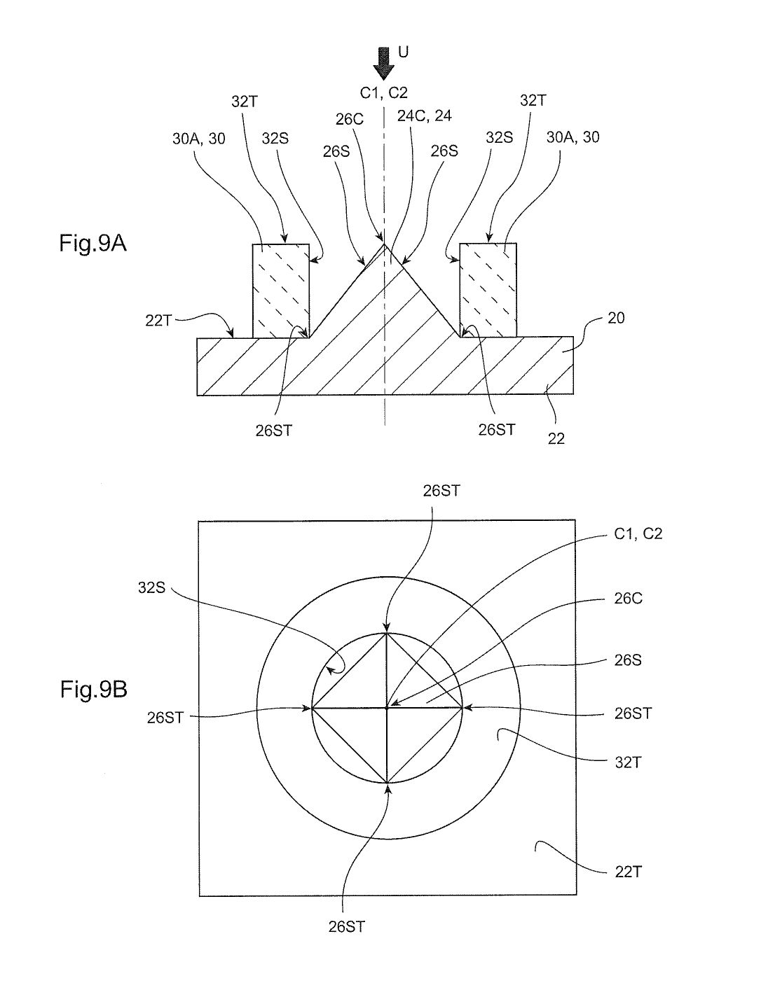

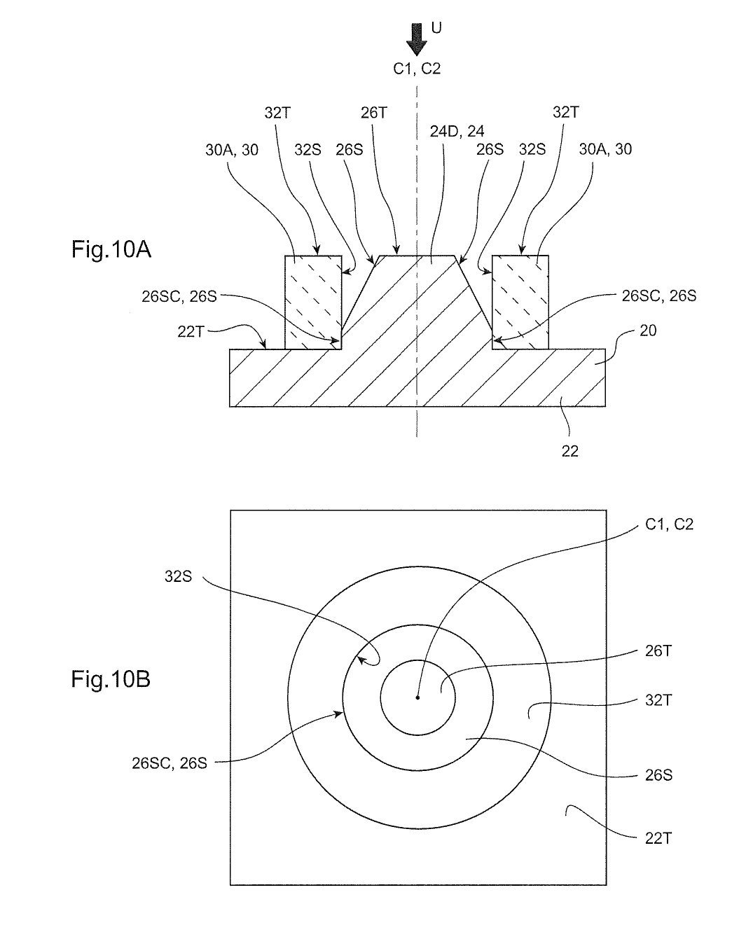

FIGS. 8 to 10 are schematic views showing other specific examples of the winding part placement step, and more specifically are views showing examples in which the outer peripheral face 26S of the core part 24, on the base 22 side thereof, is used to prevent the position of the winding part 30 from shifting. Note that FIG. 8A, FIG. 9A and FIG. 10A are schematic sectional views in the case of cutting along a plane including the central axis of the core part of the first core member. Furthermore, FIG. 8B is a top view in which the first core member 20, on which the winding part 30 has been placed, is seen from the direction of the arrow U in FIG. 8A (that is to say, a top view of the side on which the winding part 30 was placed on the first core member 20), FIG. 9B is a top view in which the first core member 20, on which the winding part 30 has been placed, is seen from the direction of the arrow U in FIG. 9A, and FIG. 10B is a top view in which the first core member 20, on which the winding part 30 has been placed, is seen from the direction of the arrow U in FIG. 10A.

Here, the shape of the core part 24B (24) shown in FIG. 8 differs from that of the cylindrical core part 24A shown in FIGS. 1 to 7, in that it is a circular frustum. Furthermore, the diameter of the core part 24B where the outer peripheral face 26S is closest to the base 22 substantially coincides with the inner diameter of the circular tubular winding part 30A. Consequently, the entire periphery of the outer peripheral face 26 of the core part 24B that is closest to the base 22 is in line contact with the entire periphery of the inner peripheral face 32S of the winding part 30A that is closest to the top face 22T. It is thereby possible to prevent the position of the winding part 30A from shifting. Note that the reference numeral 26T shown in FIG. 8 indicates the top face of the core part 24B.

Furthermore, the shape of the core part 24 is not limited to circular frusta and, for example, well-known approximately frusta such as triangular frusta, quadrangular frusta, frusta wherein the sectional shape in a plane oriented orthogonal to the central axis C1 is cruciform, or somewhat degraded forms of these shapes can be selected. Furthermore, well-known approximately conical shapes such as circular cone, triangular cone, quadrangular cone, and cone wherein the sectional shape in a plane oriented orthogonal to the central axis C1 is cruciform, or somewhat degraded forms of these shapes can be selected for the shape of the core part 24.

FIG. 9 is a view showing a variant of the example shown in FIG. 8, and more specifically showing the case in which the circular frustum core part 24B shown in FIG. 8 has been replaced by a quadrangular cone core part 24C (24). In the example shown in FIG. 9, of the outer peripheral face 26S that is closest to the base plane of the quadrangular cone core part 24C (closest to the base 22), the vertex parts 26ST corresponding to the four vertices of the base plane (which is to say, portions of the outer peripheral face 26S) are in the point contact with the inner peripheral face 32S that is closest to the top face 22T of the winding part 30A. It is thereby possible to prevent the position of the winding part 30A from shifting. Note that the reference numeral 26C shown in FIG. 9 indicates the vertex of the core part 24C.

FIG. 10 is a view showing a variant of the example shown in FIG. 8, in which the circular frustum core part 24B shown in FIG. 8 has been replaced with a core part 24D (24) in which a cylinder continues from the base plane of the circular frustum, and has an end face at that is the same shape as the base plane (approximate circular frustum). In the example shown in FIG. 10, of the outer peripheral face 26S of the core part 24D of the approximate circular frustum, the entire outer peripheral face on the base 22 side thereof (the curved face 26SC, which is the outer peripheral face of the cylinder portion that constitutes part of the core part 24) is in surface contact with the inner peripheral face 32S of the winding part 30A, on the top face 22T side thereof. It is thereby possible to prevent the position of the winding part 30A from shifting.

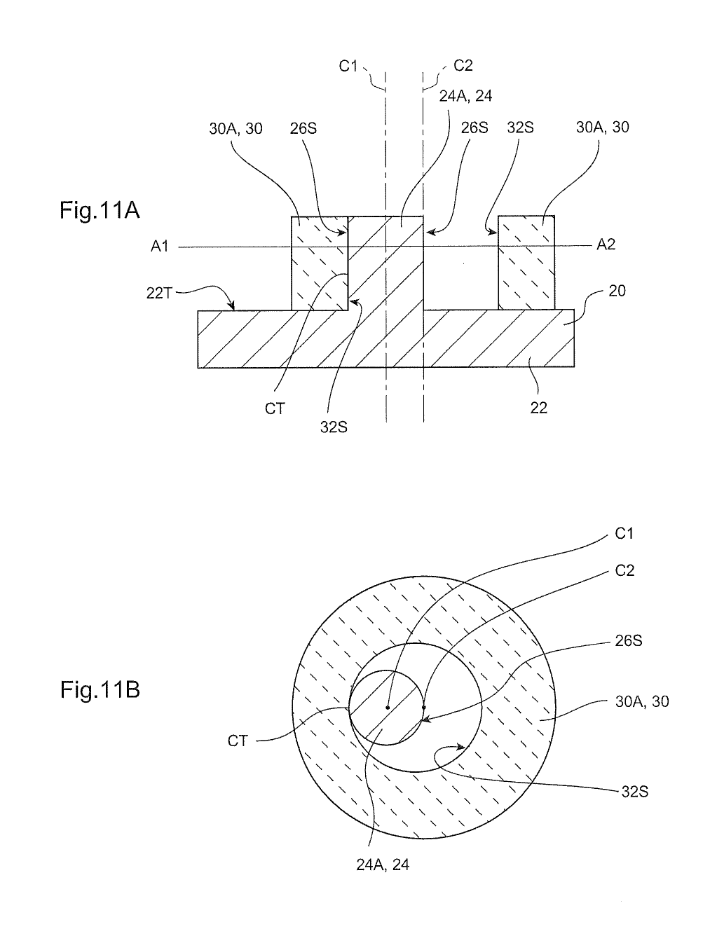

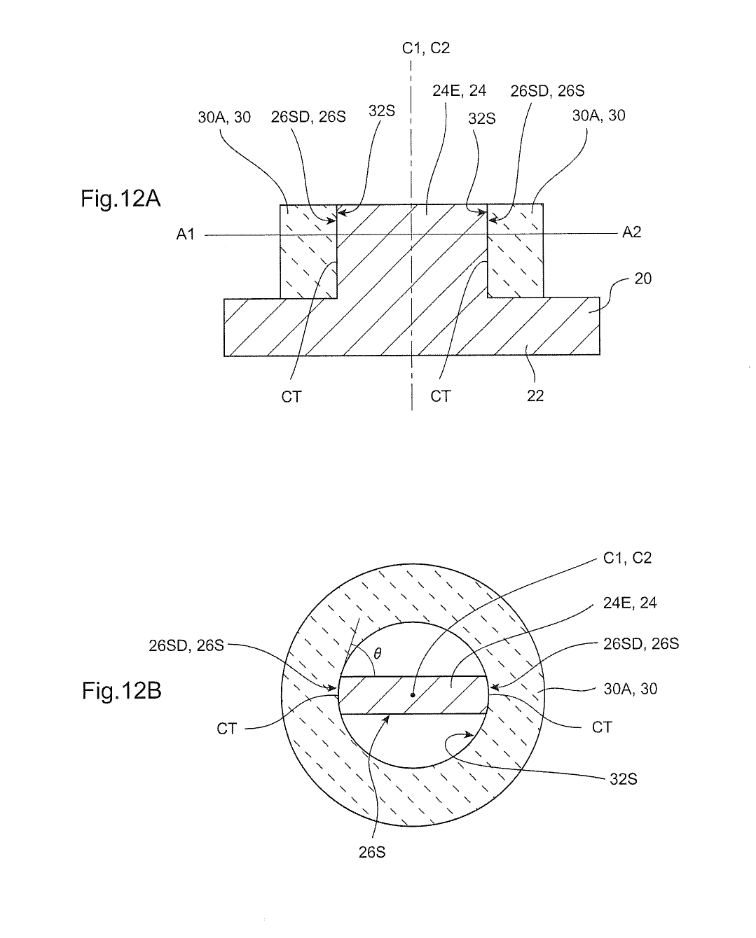

Next, specific examples of the second placement mode are shown in FIG. 11 and FIG. 12. Here, FIG. 11 is a schematic view showing another example of the winding part placement step, and FIG. 12 is a variant of the example shown in FIG. 11. Note that FIG. 11A and FIG. 12A are schematic sectional views in the case of cutting along a plane including the central axis of the core part of the first core member. Furthermore, FIG. 11B is a schematic end view in the case of cutting along a plane orthogonal to the central axis of the core part, taken along A1-A2 in FIG. 11A, and FIG. 12B is a schematic end view in the case of cutting along a plane orthogonal to the central axis of the core part, taken along A1-A2 in FIG. 12A.

In contrast with the example shown in FIG. 3 and FIG. 4, the placement mode shown in FIG. 11 shows a situation in which the central axis C1 and the central axis C2 are present at positions that are maximally distant from one another. In the example shown in FIG. 11, a contact part CT is formed wherein a portion of the inner peripheral face 32S of the winding part 30A and a portion of the outer peripheral face 26S of the core part 24A are in line contact, extending in the direction of the central axis C1 of the core part 24A. That is to say, in the second placement mode illustrated from FIG. 11 onwards, a contact part CT, wherein a portion of the inner peripheral face 32S of the winding part 30A and a portion of the outer peripheral face 26S of the core part 24 are in contact, is formed so as to extend in a direction parallel to the central axis C1.

Note that, in the example shown in FIG. 11, there is only one contact part CT in the peripheral direction of the core part 24A. Consequently, in the injection molding step, it is easy for the position of the winding part 30A to shift, and as a result there is a tendency for greater inconsistencies in quality, such as in the electrical characteristics of the magnetic element that is produced.

In order to avoid such problems, in the method of manufacturing a magnetic element of the present mode of embodiment, it is preferable to provide two or more contact parts CT in the peripheral direction of the core part 24. As a result, it is easily possible to prevent the position of the winding part 30 from shifting. However, if the two or more contact parts CT that are provided in the peripheral direction of the core part 24 are concentrated in positions that are not evenly distributed in the peripheral direction, problems similar to those of the example shown in FIG. 11 may tend to occur. Thus, it is further preferable that the two or more contact parts CT be arranged at positions distanced from each other to the greatest extent possible, and still further particularly preferable that these be arranged at approximately point symmetric positions, with respect to the central axis C1 of the core part 24. As a result, it is possible to reliably prevent the position of the winding part 30 from shifting.

FIG. 12 shows an example in which, in place of the core part 24A shown in FIG. 11, an approximately quadrangular columnar core part 24E (24) is used, the sectional shape of which, in a plane orthogonal to the central axis C1 (hereinafter also referred to simply as the horizontal sectional shape), is approximately rectangular. Here, those portions of the outer peripheral face 26S of the core part 24E facing the inner peripheral face 32S of the tubular winding part 30A have curved faces 26SD (portions of the outer peripheral face 26S) that approximately correspond to the inner peripheral face 32S. Here, one of the curved faces 26SD is in surface contact with the inner peripheral face 32S of the winding part 30A so as to form a contact part CT, and the other curved face 26SD is in surface contact with the inner peripheral face 32S of the winding part 30A so as to form another contact part CT. Next, these 2 contact parts CT are formed at positions that are point symmetric in the peripheral direction of the core part 24E.

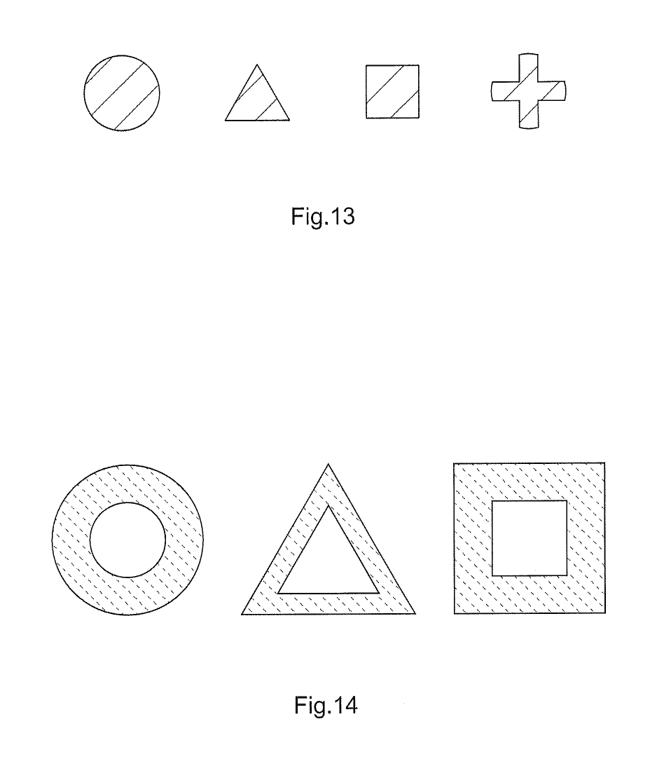

Note that, in the method of manufacturing a magnetic element of the present mode of embodiment, there are no particular restrictions on the horizontal sectional shape of the core part 24, or on the horizontal sectional shape of the winding part 30, and in both of the first placement mode and the second placement mode, arbitrary horizontal sectional shapes can be freely adopted. However, with a view to (1) the ease of designing the magnetic element, (2) the productivity for the magnetic element and/or, (3) the ease of arranging the two or more contact parts CT at approximately symmetrical positions with respect to the central axis C1 of the core part 24, it is preferable that the horizontal sectional shape of the core part 24 be approximately point symmetric with respect to the central axis C1, or approximately line symmetric with respect to a radial direction including the central axis C1, and is preferable that the horizontal sectional shape of the winding part 30 be approximately point symmetric with respect to the central axis C2, or approximately line symmetric with respect to a radial direction including the central axis C2. In addition, it is particularly preferred that the horizontal sectional shape of the core part 24 be (approximately) circular, (approximately) equilateral triangular, (approximately) square, or (approximately) cruciform, as illustrated in FIG. 13, and it is particularly preferred that the horizontal sectional shape of the winding part 30 be (approximately) concentrically circular, (approximately) concentrically equilateral triangular, or (approximately) concentrically square, as illustrated in FIG. 14. Note that, to be (approximately) concentrically equilateral triangular and (approximately) concentrically square, it is necessary that the inner peripheral sides and the outer peripheral sides be (approximately) parallel.

Here, when consideration is given to simultaneously satisfying (1) to (3) described above and the horizontal sectional shapes shown in FIG. 13 and FIG. 14, it is preferable that any one combination from among the combinations indicated below in (A) to (F) be selected as the combination for the outer peripheral profile shape of the core part 24 and the inner peripheral profile shape of the winding part 30:
(A) a combination of an approximately circular shape and an approximately triangular shape;
(B) a combination of an approximately circular shape and an approximately quadrangular shape;
(C) a combination of an approximately triangular shape and an approximately circular shape;
(D) a combination of an approximately quadrangular shape and an approximately circular shape;
(E) a combination of an approximately cruciform shape and an approximately circular shape; and
(F) a combination of an approximately cruciform shape and an approximately quadrangular shape.

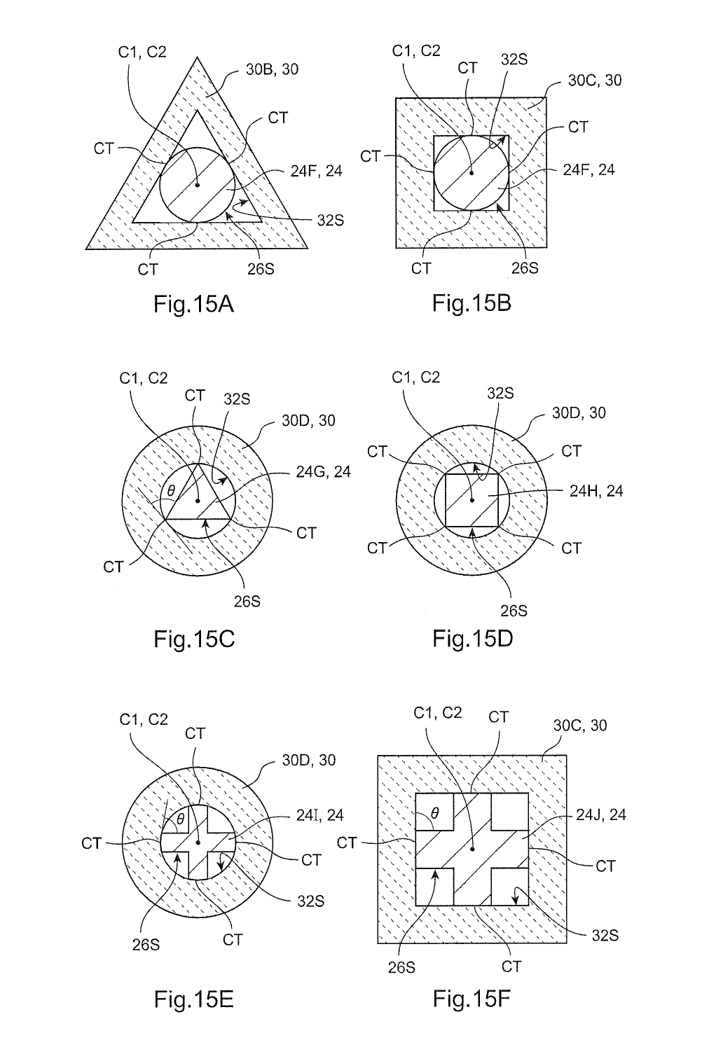

FIG. 15 is a view showing other specific examples of the second placement mode, and more specifically this is a schematic sectional view showing examples of combinations of horizontal sectional shapes of the core part 24 and horizontal sectional shapes of the winding part 30, which correspond to the combinations of the outer peripheral profile shapes of the core part 24 and the inner peripheral profile shapes of the winding part 30 indicated in (A) to (F) above. Here, the views FIG. 15A to FIG. 15F indicate, in terms of horizontal sectional shapes, a combination of a circular core part 24F (24) and a concentric equilateral triangular winding part 30B (30); a combination of a circular core part 24F (24) and a concentric square winding part 30C (30); a combination of an equilateral triangular core part 24G (24) and a concentric circular winding part 30D (30); a combination of a square core part 24H (24) and a concentric circular winding part 30D; a combination of an approximately cruciform core part 24I (24) and a concentric circular winding part 30D; and a combination of a cruciform core part 24J (24) and a concentric square winding part 30C.

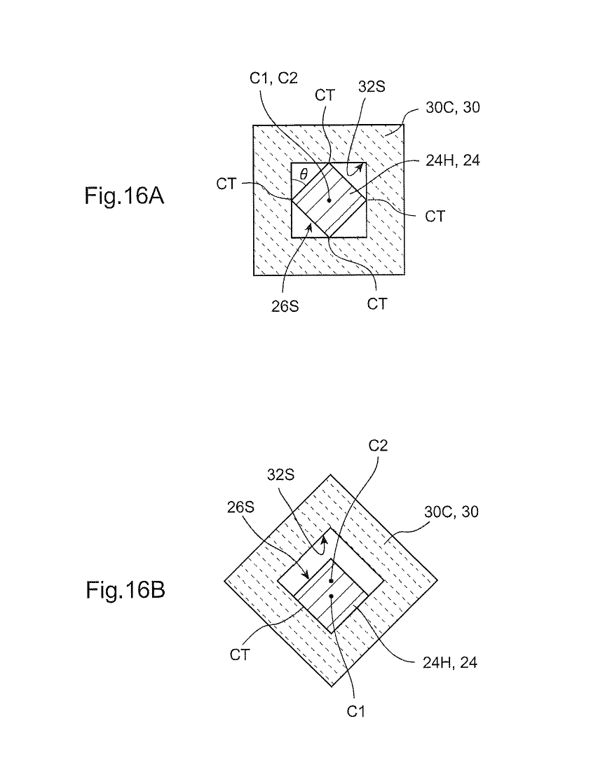

Note that, in terms of simultaneously satisfying (1) to (3) described above and the horizontal sectional shapes shown in FIG. 13 and FIG. 14, in addition to those illustrated in FIG. 15, in terms of horizontal sectional shapes, for example, combinations of a square core part 24H and a concentric square winding part 30C such as shown in FIG. 16A can be adopted for the combination of the horizontal sectional shape of the core part 24 and the horizontal sectional shape of the winding part 30. That is to say, a combination of an approximately quadrangular shape and an approximately quadrangular shape can be adopted for the combination of the outer peripheral profile shape of the core part 24 and the inner peripheral profile shape of the winding part 30. In the example shown in FIG. 16A, four contact parts CT wherein the outer peripheral face 26S and the inner peripheral face 32S are in point contact, are provided every 90° in the peripheral direction. However, with the placement mode shown in FIG. 16A, it is possible that the winding part 30C will rotate in the peripheral direction when injection molding is performed. Next, if the winding part 30C is rotated in the peripheral direction, as illustrated in FIG. 16B, as a result of movement of the winding part 30C such that the central axis C1 and the central axis C2 are distanced from each other, a change in the relative positional relationship between the core part 24 and the winding part 30C arises. Consequently, there may be cases in which inconsistencies in quality, such as in the electrical characteristics of the magnetic element, occur due to shifting of the position of the winding part 30.

As opposed to this, with the combinations illustrated in FIG. 15A to 15E, while it is possible that the winding part 30B, 30C, 30D will rotate in the peripheral direction when injection molding is performed, in this case, there will be no change in the relative positional relationship between the core part 24 and the winding part 30. In addition to this, with the combination illustrated in FIG. 15F, because four contact parts CT are provided wherein the outer peripheral face 26S and the inner peripheral face 32S are in surface contact, every 90° in the peripheral direction, the winding part 30 will not rotate in the peripheral direction when injection molding is performed. That is to say, in the example shown in FIG. 15, there is no room for the central axis C1 and the central axis C2 to approach each other or to be distanced from each other, and therefore there is absolutely no room for inconsistency in the relative positional relationship between the core part 24 and the winding part 30, whereby it is possible to reliably prevent inconsistencies in quality, such as in electrical characteristics of the magnetic element, due to shifting of the position of the winding part 30B, 30C, 30D.

Note that, in the second placement mode illustrated in FIG. 11, FIG. 12, FIG. 15 and FIG. 16, with the exception of the contact parts CT and the portions in the vicinity of the contact parts CT, the outer peripheral face 26S and the inner peripheral face 32S are greatly distanced from each other. Thus, the distance between the outer peripheral face 26S and the inner peripheral face 32S is considerably greater than the dimensional clearance provided between the outer peripheral face 226S and the inner peripheral face 232S of the magnetic element 200 shown in FIG. 17. Accordingly, when injection molding is performed, this can be filled with the magnetic resin without leaving gaps, other than at the contact parts CT and at portions in the vicinity of the contact parts CT. Conversely, at the contact parts CT, the outer peripheral face 26S and the inner peripheral face 32S are substantially in contact, such that the distance between the two is approximately the same as the clearance. In addition, the distance between the outer peripheral face 26S and the inner peripheral face 32S in the vicinity of the contact part CT is very close to that of the clearance. Accordingly, when injection molding is performed, sufficient filling with the magnetic resin is not possible at the contact part CT, and in the vicinity of the contact part CT, and thus gaps readily form.

In consideration of such matters, modes in which the contact parts CT are not in surface contact, but rather in line contact (for example FIG. 11, FIG. 15A, FIG. 15B, FIG. 15C, FIG15D, FIG. 16A) or modes in which the contact parts CT are in surface contact with a narrow contact width in the peripheral direction are preferred. Furthermore, it is preferable that, in the vicinity of the contact parts CT, the angle 8 formed by a tangent to the outer peripheral face 26S and a tangent to the inner peripheral face 32S, in the direction of a plane orthogonal to the central axes C1, C2 (horizontal plane direction) be large (for example FIG. 12, FIG. 15C, FIG. 15E, FIG. 15F, FIG. 16A).

Note that, also in placement modes such as those illustrated in FIGS. 8 to 10, in which the outer peripheral face 26S of the core part 24, on the base 22 side thereof, is used to prevent shifting of the winding part 30, in terms of the mode of contact between the outer peripheral face 26S and the inner peripheral face 32S in the vicinity of the base 22 side thereof, it is preferable to use modes of contact similar to those in the second placement mode, illustrated in FIG. 11B, FIG. 12B, FIG. 15 and FIG. 16.

In terms of the magnetic resin used in the method of manufacturing a magnetic element in the mode of embodiment described above, there are no particular restrictions on the magnetic resin used, so long as this is a known magnetic resin that is used to produce magnetic elements. However, in the method of manufacturing a magnetic element of the present mode of embodiment, it is preferable to use a magnetic resin with which, when producing a conventional magnetic element 200, gaps readily form during injection molding due to the high relative viscosity thereof. Such a magnetic resin is preferably a magnetic resin in which the magnetic powder content ratio is 75 mass percent or greater, or 33 volume percent or greater. Note that, based on mass percent, the content ratio is more preferably 86 mass percent or greater, and while there is no particular upper limit, in practical terms, this is preferably no greater than 97%. Furthermore, based on volume percent, the content ratio is more preferably 50% or greater, and while there is no particular upper limit, in practical terms, is preferable that this be no greater than 80 volume percent.

Moreover, known resin materials can be used as the resin material from which the magnetic resin is made, but the use of nylon resin is preferred as, in comparison with other resins, it is fibrous, and greater quantities of magnetic powder can readily be held dispersed therein.

Furthermore, in the manner of the magnetic element 10 illustrated in FIG. 1, the magnetic element manufactured by way of the method of manufacturing a magnetic element of the present mode of embodiment may have a symmetrical structure with respect to the direction orthogonal to the direction of the central axis C1 and/or the direction of the central axis C1, but this may also have an asymmetrical structure with respect thereto. Nonetheless, with a view to maintaining the stability of electrical characteristics, such as the inductance characteristics and the saturation characteristics, a highly symmetrical structure is preferred. From this point of view, it is particularly preferred that the thickness of the base 22 of the first core member 20, and the thickness of the bottom portion of the second core member 40 (the portion that contacts the core part 24 and the winding part 30 in the direction of the central axis C2) be substantially the same. Moreover, in order to prevent interfacial separation of the first core member 20 and the second core member 40 as a result of thermal deformation, it is preferable that the coefficients of thermal expansion of the magnetic resin from which the first core member 20 is made and the magnetic resin from which the second core member 40 is made be approximately the same. In this case, it is particularly suitable that the composition of the magnetic resin from which the first core member 20 is made and the composition of the magnetic resin from which the second core member 40 is made be substantially the same.

Furthermore, while there are no particular restrictions on the usage of the magnetic element manufactured by way of the method of manufacturing a magnetic element of the present mode of embodiment, it is preferable that these be used as reactors or inductors employed primarily in compact power sources.

1. A method of manufacturing a magnetic element having:
a first core member made from a resin material in which a magnetic powder is dispersed, and having an substantially plate-like base and a core part protruding from the approximate center of one face of the base;
a winding part formed as a tube by winding a conductive wire, which is placed on the base such that the core part is positioned within an inner periphery of the tube; and,
a second core member made from a resin material in which a magnetic powder has been dispersed, which is provided so as to surround a side of the first core member on which the core part is provided and the winding part,
the method comprising at least:
a winding part placement step of placing the winding part on the face of the first core member on the side on which the core part is provided, such that the core part is positioned within the inner periphery of the winding part; and
an injection molding step of injection molding so as to surround the side of the first core member on which the core part is provided and the winding part with the resin material in which the magnetic powder has been dispersed,
wherein, in the winding part placement step, the winding part is placed on the face of the first core member on the side on which the core part is provided, with at least a portion of an inner peripheral face of the winding part distanced from an outer peripheral face of the core part.

2. The method of manufacturing a magnetic element according to claim 1,
wherein, in the winding part placement step, the winding part is placed on the face of the first core member on the side on which the core part is provided, with at least substantially the entire surface of the inner peripheral face of the winding part, other than in the vicinity of a base side thereof, distanced from the outer peripheral face of the core part.

3. The method of manufacturing a magnetic element according to claim 2,
wherein an outer peripheral profile shape of the core part and an inner peripheral profile shape of the winding part are similar, and
in the winding part placement step, the winding part is placed on the face of the first core member on the side on which the core part is provided, such that a central axis of the core part and a central axis of the winding part approximately coincide.

4. The method of manufacturing a magnetic element according to claim 2,
further comprising providing a step on the face of the base on the side on which the core part is provided, on at least a portion of a line corresponding to at least one diameter selected from the inner diameter and the outer diameter of the winding part, at which a central axis of the core part and a central axis of the winding part are assumed to approximately coincide.

5. The method of manufacturing a magnetic element according to claim 2,
wherein, the shape of the core part is any one shape selected from an approximately conical shape, a base-plane side of which is oriented toward the base, and an approximately frustum shape, a base-plane side of which is oriented toward the base, and
in the winding part placement step, at least a portion of the outer peripheral face of the core part on the base side thereof, and at least a portion of the inner peripheral face of the winding part make contact.

6. The method of manufacturing a magnetic element according to claim 1,
wherein, in the winding part placement step, the winding part is placed on the face of the first core member on the side on which the core part is provided, such that a portion of the inner peripheral face of the winding part and a portion of the outer peripheral face of the core part make contact, extending in the direction of a central axis of the core part.

7. The method of manufacturing a magnetic element according to claim 6,
wherein there are two or more contact parts where a portion of the inner peripheral face of the winding part and a portion of the outer peripheral face of the core part make contact, extending in the direction of the central axis of the core part.

8. The method of manufacturing a magnetic element according to claim 7,
wherein the two or more contact parts are arranged at approximately point symmetric positions with respect to the central axis of the core part.

9. The method of manufacturing a magnetic element according to claim 8, wherein a combination of an outer peripheral profile shape of the core part and an inner peripheral profile shape of the winding part is at least one combination selected from:
(A) a combination of an approximately circular shape and an approximately triangular shape;
(B) a combination of an approximately circular shape and an approximately quadrangular shape;
(C) a combination of an approximately triangular shape and an approximately circular shape;
(D) a combination of an approximately quadrangular shape and an approximately circular shape;
(E) a combination of an approximately cruciform shape and an approximately circular shape; and
(F) a combination of an approximately cruciform shape and an approximately quadrangular shape.

10. A magnetic element comprising: a first core member made from a resin material in which a magnetic powder is dispersed, and having a substantially plate-like base and a core part protruding from the approximate center of one face of the base;
a winding part, formed as a tube by winding a conductive wire, which is placed on the base such that the core part is positioned within an inner periphery of the tube; and
a second core member made from a resin material in which a magnetic powder has been dispersed, which is provided so as to surround a side of the first core member on which the core part is provided and the winding part,
the magnetic element being manufactured by way of at least:
a winding part placement step of placing the winding part such that the core part is positioned within the inner periphery of the winding part; and
an injection molding step of injection molding using the resin material in which the magnetic powder has been dispersed, so as to surround the side of the first core member on which the core part is provided and the winding part,
wherein, in the winding part placement step, the winding part is placed on the face of the first core member on the side on which the core part is provided, with at least a portion of an inner peripheral face of the winding part distanced from an outer peripheral face of the core part.
